(19) United States
(12) Patent Application Publication
(10) Pub. No.: US 2024/0412308 A1
(43) Pub. Date: Dec. 12, 2024

(54) METHOD FOR BUILDING CONFIGURATION AND RECONFIGURATION OF A PANELIZED STRUCTURAL BUILDING SYSTEM

(71) Applicant: Cover Technologies, Inc., Gardena, CA (US)

(72) Inventors: Jemuel Joseph, Gardena, CA (US); Connor Holjes, Gardena, CA (US); Stanley Chen, Gardena, CA (US); Alexis Xavier Rivas, Gardena, CA (US)

(21) Appl. No.: 18/412,184

(22) Filed: Jan. 12, 2024

Related U.S. Application Data
(60) Provisional application No. 63/438,679, filed on Jan. 12, 2023.

(51) Int. Cl. G06Q 50/16; G06F 30/13

(52) U.S. Cl. CPC G06Q 50/165; G06F 30/13

(57) ABSTRACT

A method includes: accessing a set of future preferences of a user; accessing a set of building code requirements for a build location of a residential structure of the user; selecting a set of future configurations fulfilling the set of building code requirements and the set of future preferences of the user; and accessing a set of initial preferences of the user. The method further includes, for each future configuration: segmenting the future configuration into a set of building elements; generating an initial building configuration based on the set of building elements, fulfilling the set of initial preferences of the user, and maximizing reuse of the set of building elements; and in response to receiving user selection of the initial building configuration, generating a schedule to augment the initial building configuration with additional building elements to yield the future configuration.

### CROSS-REFERENCE TO RELATED APPLICATIONS

This application claims the benefit of U.S. Provisional Application No. 63/438,679, filed on 12 Jan. 2023, which is incorporated in its entirety by this reference.

### TECHNICAL FIELD

This invention relates generally to the field of prefabricated structures and more specifically to a new and useful method for configuring an initial panelized structure based on a set of future preferences for a future panelized structure.

### BRIEF DESCRIPTION OF THE FIGURES

FIG. 1 is a flowchart representation of one variation of the method;

FIG. 2 is a flowchart representation of one variation of the method;

FIG. 3 is a flowchart representation of one variation of the method; and

FIG. 4 is a flowchart representation of one variation of the method.

### DESCRIPTION OF THE EMBODIMENTS

The following description of embodiments of the invention is not intended to limit the invention to these embodiments but rather to enable a person skilled in the art to make and use this invention. Variations, building configurations, implementations, example implementations, and examples described herein are optional and are not exclusive to the variations, building configurations, implementations, example implementations, and examples they describe. The invention described herein can include any and all permutations of these variations, building configurations, implementations, example implementations, and examples.

### 1. Method

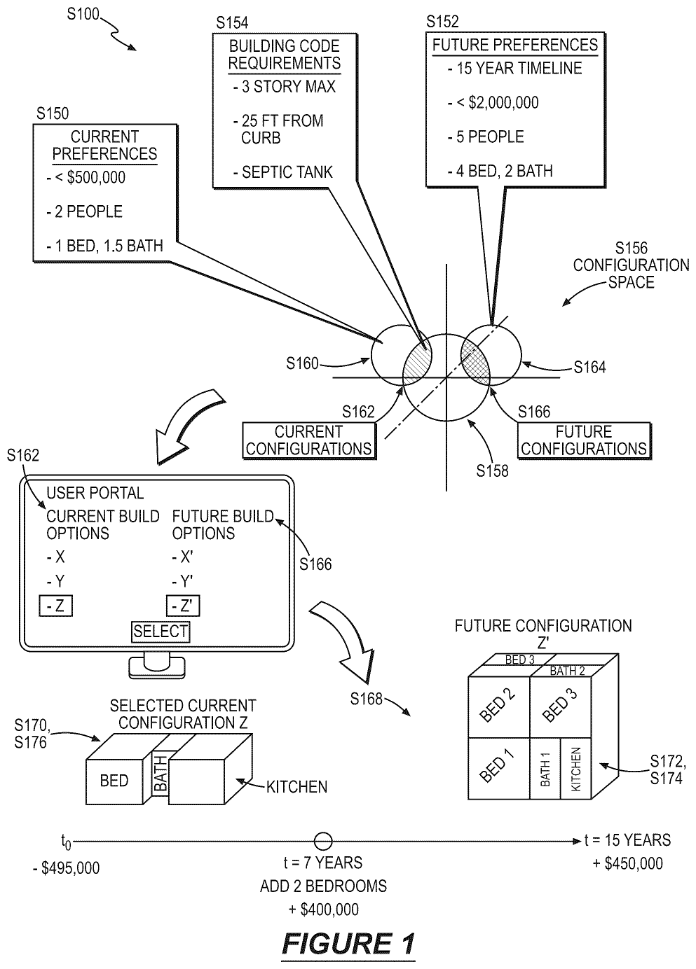

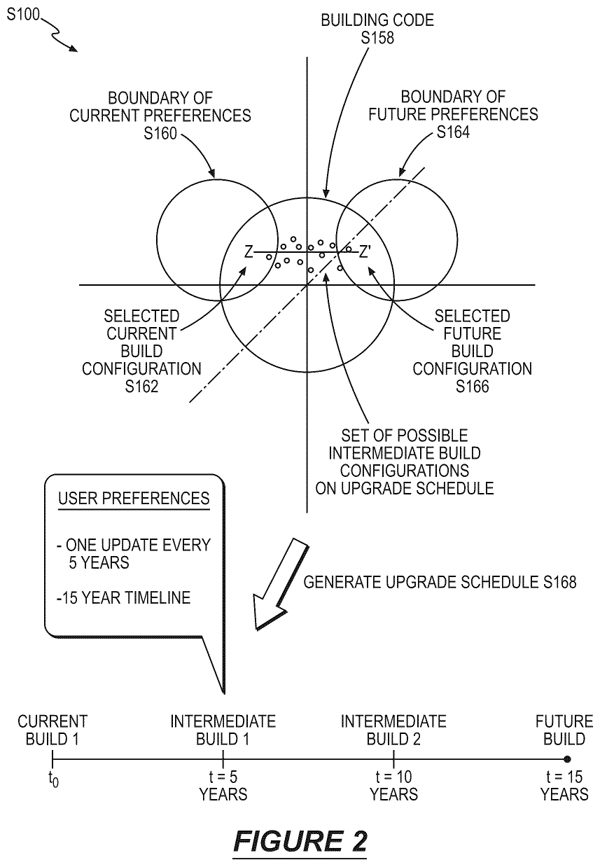

In one implementation, the method S100, as shown in FIGS. 1 and 2, includes: accessing a set of initial preferences of a user for a residential structure of the user in Block S150; accessing a set of future preferences of the user for the residential structure in Block S152; accessing a set of building code and zoning requirements for a build location of the residential structure in Block S154; defining a multi-dimensional space of possible building configurations, each building configuration representing a combination of prefabricated building element arrangements in Block S156; selecting a set of initial building configurations from a set of possible building configurations by projecting a set of boundaries into the multi-dimensional space including a first boundary defining a first volume of the multi-dimensional space including a set of building configurations fulfilling the building code and zoning requirements of the build location in Block S158; a second boundary defining a second volume including a set of building configurations fulfilling the initial preferences of the user in Block S160; and deriving a first intersection of the first volume and the second volume, the first intersection including the set of initial building configurations fulfilling the building code and zoning requirements of the build location and fulfilling the initial preferences of the user in Block S162.

The method also includes: selecting a set of future configurations from a set of possible building configurations by projecting a third boundary into the multi-dimensional space, the third boundary defining a third volume including a set of building configurations fulfilling the future preferences of the user in Block S164; deriving a second intersection of the first volume and the third volume, the second intersection including the set of future configurations fulfilling the building code and zoning requirements of the build location and fulfilling the future preferences of the user in in Block S166; in response to user selection of a first initial building configuration in the set of initial building configurations and a first future configuration in the set of future configurations, generating a schedule to augment the initial building configuration with additional prefabricated building elements to transform the initial building configuration into the future configuration in Block S168.

### 1.1 Method Variation: Initial Build Based on Future Build

In one implementation, a variation of the method S100 includes: accessing a set of future preferences of a user in Block S152; accessing a set of building code and zoning requirements for a build location of a residential structure of the user in Block S154; selecting a set of future configurations from a set of possible building configurations, the subset of future configurations fulfilling the set of building code and zoning requirements and approximating the set of future preferences of the user in Block S160; and accessing a set of initial preferences of the user in Block S150.

For each future configuration in the set of future configurations, the computer system then: segments the future configuration into a set of prefabricated building elements in Block S170; generates an initial building configuration based on the set of prefabricated building elements, the initial building configuration fulfilling the set of initial preferences of the user, maximizing reuse of the set of prefabricated building elements, and minimizing a number of new prefabricated building elements in Block S172; and, in response to receiving user selection of the initial building configuration, generates a schedule to augment the initial building configuration with additional prefabricated building elements to transform the initial building configuration into the future configuration in Block 168.

### 1.2 Method Variation: Future Build Based on Initial Build

In one implementation, a variation of the method S100 includes generating a future configuration based on an initial building configuration.

In this variation, the method S100 includes: accessing a set of initial preferences of a user in Block S150; accessing a set of building code requirements for a build location of a residential structure in Block S154; selecting a set of initial building configurations from a set of possible building configurations approximating the set of initial preferences of the user and fulfilling the set of building code requirements in Block S164; and accessing a set of future preferences of in Block S152 a user.

For each initial building configuration in the set of initial building configurations, the method S100 includes: identifying a set of building elements specified in the initial building configuration; generating a future configuration based on the set of building elements, the future configuration fulfilling the set of future user parameters and specifying more than a minimum threshold proportion of building elements in the set of building elements in Block S172; generating a first virtual representation of the initial building configuration; generating a second virtual representation of the future configuration in Block S174; displaying the first virtual representation and the second virtual representation in Block S176; and in response to selection of the first virtual representation, generating a remodel schedule to convert the initial building configuration of the first virtual representation to the future build configuration of the first virtual representation in Block S168.

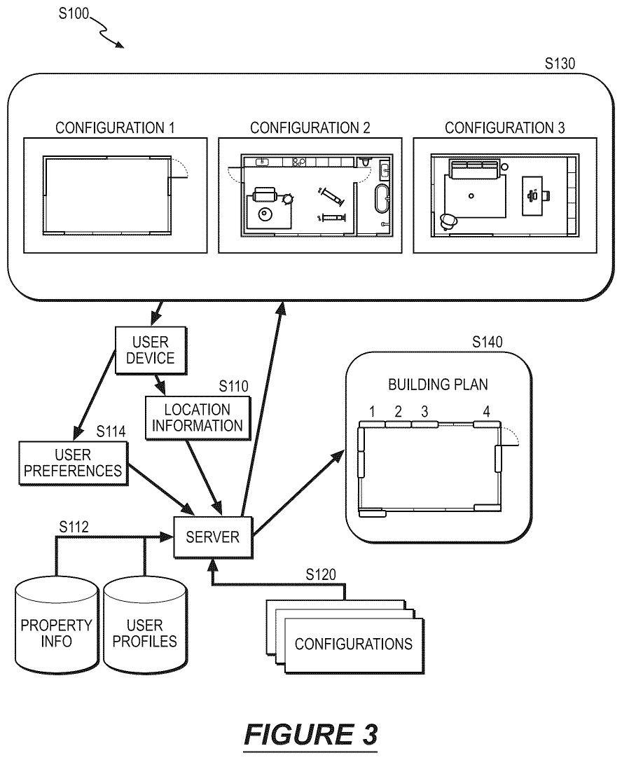

Further, as shown in FIG. 3, a method S100 for configuring a panelized structural building system includes: accessing location information associated with a lot in Block S110; accessing property information based on the location information in Block S112; accessing a set of user preferences of a user in Block S114; selecting a subset of building configurations, in a set of building configurations of a structure (e.g., a home) assembled from prefabricated building elements, based on the property information and the set of user preferences in Block S120; and serving the subset of building configurations to the user in Block S130. The prefabricated building elements can include: wall panels of a common geometry; floor panels of a common geometry; roof panels of a common geometry; window and door panels of a common geometry; exterior façade panels of a common geometry; and/or interior finishing panels of a common geometry.

The method S100 further includes: receiving selection of a first building configuration in the subset of building configurations; and autonomously generating a first building plan for the first building configuration in Block S140. Generally, the first building plan can: identify a first set of prefabricated building elements; and specify a first arrangement of the first set of prefabricated building elements for assembly of a first structure according to the first building configuration. The first set of prefabricated building elements can include: a first set of wall panels; a first set of floor panels; a first set of roof panels; a first set of exterior façade panels; and/or a first set of interior finishing panels. The first building plan can further specify a sequence for arranging each prefabricated building element in the first set of prefabricated building elements according to the first arrangement.

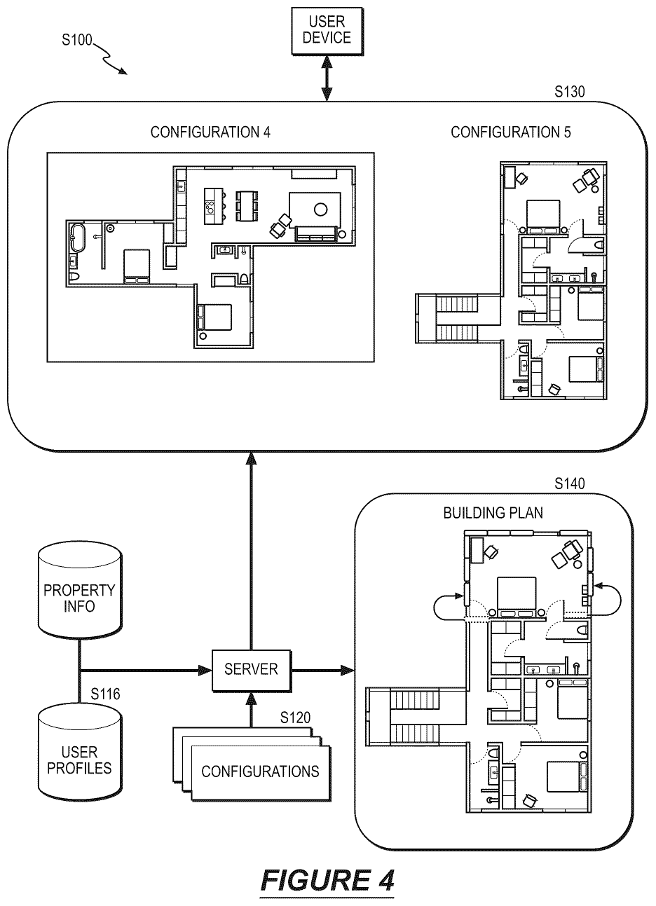

As shown in FIG. 4, the method S100 also includes, in response to detecting a reconfiguration event, accessing a user profile in Block S116, the user profile including: location information associated with a lot; property information; a set of user preferences; and a first building plan identifying the first set of prefabricated building elements and specifying the first arrangement of the first set of prefabricated building elements for assembly of the first structure according to the first building configuration.

The method S100 further includes: selecting a second subset of building configurations, in the set of building configurations, based on the property information, the set of user preferences, the first building plan, and the reconfiguration event in Block S120; and serving the second subset of building configurations to the user in Block S130. The method S100 further includes, in response to receiving selection of a second building configuration in the second subset of building configurations, generating a second building plan for the second building configuration in Block S140. Generally, the second building plan can: identify a second set of prefabricated building elements; and specify a second arrangement of the second set of prefabricated building elements for assembly of a second structure according to the second building configuration. The second set of prefabricated building elements can include: a second set of wall panels including a subset of the first set of wall panels; a second set of floor panels including a subset of the first set of floor panels; a second set of roof panels including a subset of the first set of roof panels; a second set of exterior façade panels including a subset of the first set of exterior façade panels; and/or a second set of interior finishing panels including a subset of the first set of interior finishing panels. The second building plan can further specify a sequence for arranging each prefabricated building element in the second set of prefabricated building elements according to the second arrangement.

### 2. Applications

Generally, Blocks of the method S100 can be executed by a computer system to: configure a panelized structural building system based on property information (e.g., physical constraints of a lot, legal constraints) and a set of user preferences (e.g., cost, size); and generate a first building plan specifying a first arrangement of prefabricated building elements (e.g., wall panels, floor panels, ceiling panels, exterior façade panels, interior finishing panels) for assembly of a first structure according to the building configuration and a sequence for arranging each prefabricated building element according to the first arrangement. The computer system can execute Blocks of the method S100 to additionally: generate an initial building configuration based on initial preferences of the user; generate a future configuration based on future preferences of the user; and define a remodel schedule to transform the initial building configuration into the future configuration.

### 2.1 Future Building Configuration

In one implementation, the computer system aids a user in designing a future building configuration that fulfills the user's current perception of her future preferences and/or needs. The user's projected future preferences can include: a budget; living space parameters (e.g., a quantity of bedrooms and bathrooms); and a lifestyle selection (e.g., a preference for large common spaces to entertain).

In one implementation, the computer system can: iterate on future building configurations based on user feedback; verify each future building configuration meets requirements including livability and building code and zoning compliance; and, in response to the future building configuration not fulfilling the requirements, generate a refined future building configuration to converge on a future building configuration fulfilling the user preferences and requirements.

The computer system can then automatically generate a future building plan that reflects the future building configuration, such as including: a layout; an elevation; a structural component list; and exterior façade component list; an interior façade component list; and a component placement for each component.

### 2.2 Initial Building Configuration

Then, the computer system can access current user needs: including a current budget; current lifestyle; and current living space needs (e.g., a minimum number of bedrooms and bathrooms). The computer system can develop an initial building configuration based on the current user need specifying: a minimum quantity of structural, exterior façade, and interior façade components not enumerated in the future configuration; and a minimum quantity of positional changes of structural components from the initial building configuration to the future building configuration. Before presenting the initial building configuration to the user, the computer system: verifies that the initial budling configuration meets requirements including current livability standards, budget, and code compliance; and iteratively refines the initial building configuration to converge on an initial building configuration fulfilling the current user needs and meeting the requirements. The system can: generate a visualization of this initial building configuration; render the visualization for the user; in response to user rejection of the initial building configuration, refines the initial building configuration by permitting more deviation from the component list between the future and initial building configuration and presents the refined building configuration to the user; and, in response to user approval of the initial building configuration, generates a remodel schedule to transform the initial building configuration to the future building configuration.

### 2.3 Remodel Schedule

In one implementation, the computer system executes the method S100 to generate a remodel schedule for renovating the initial building configuration to the future configuration. The computer system can: access a projected future income and/or budget of the user; access a timeline for renovation (e.g., conversion from the initial build to the future build in five or ten years); and derive the remodel schedule to meet the timeline and budget of the user.

In one implementation, the computer system defines multiple possible renovation schedules from one initial building configuration to multiple future building configurations approximating the future building configuration generated based on the projected future user preferences.

### 2.4 Intermediate Building Configurations

In one implementation, the computer system defines a set of intermediate building configurations within the remodel schedule, each intermediate building configuration representing a renovation of a previous building configuration biased toward the future configuration goal. Based on the timeline and budget of the user, the computer system defines the intermediate building configurations to include a set of new prefabricated building elements, thereby including additional features to the home of the user.

Once the system selects the initial and future building configurations, the system can: find discrete intermediate building configurations between the initial building configuration and the future building configuration. In one implementation, the computer system can query the user to specify: a quantity of remodels to achieve the future building configuration; an approximate date for each remodel; an approximate investment in each remodel; and an approximate date for completion of the future building configuration. Then, the computer system: defines a difference between the initial building configuration and the future building configuration (e.g., a set of prefabricated building elements included in the future building configuration and excluded from the initial building configuration); segments the difference into a quantity of discrete remodels defining a set of complete room groups based on the user preference for the quantity of remodels; and generates a remodel plan for adding each room group to the building configuration according to the user's preferences. As described above the computer system can iteratively verify that each intermediate building configuration fulfills the user preferences and building requirements to generate a set of refined intermediate building configurations.

### 3. Terms

Generally, a “lot” as referred to herein is a parcel of land including any features and/or structures thereon.

Generally, a “building configuration” as referred to herein is a floorplan layout for a panelized structural building system including a set of rooms and/or a set of fixtures.

Generally, a “building plan” as referred to herein is an arrangement of prefabricated building elements to assemble a structure according to a building configuration and/or a sequence for arranging each prefabricated building element according to the arrangement.

Generally, a “remodel schedule” as referred to herein is a timeline of renovations to an “initial building configuration” the transform the initial building configuration into the “future building configuration.” the remodel schedule may include building configurations between the initial and future building configurations, referred to herein as “intermediate building configurations.”

### 4. Example

Generally, the computer system can: generate a building plan for an initial build based on initial user preferences; identify a building configuration for a future build based on future preferences of the user; and generate a remodel schedule to convert the initial build to the future build.

In one implementation, the computer system can: access a set of initial user preferences including an initial budget and number of household members; access a set of future preferences of the user including a duration until completion of the future configuration, a future budget, and a projected number of future household members; and access a set of building code requirements for a build location of a residential structure for the user including structural requirements and zoning requirements.

The computer system can then identify a set of future configurations by: identifying a set of future configurations fulfilling the zoning requirements and the structural requirements; and filtering the subset of future configurations to bias each future configuration toward the future budget, duration, and projected household members. The computer system can generate an initial building configuration by: identifying a subset of prefabricated building elements used to generate the future configuration; and generating the initial building configuration fulfilling the initial budget and building code and zoning requirements according to the subset of prefabricated building elements. Finally, the computer system can generate a remodel plan for conversion of the initial building configuration into the future configuration according to the user preferences.

In one implementation, the computer system can generate a future configuration based on an initial building configuration and duration until completion of the future configuration. The computer system can: identify a set of initial building configurations that fulfil the zoning and structural requirements; and filter the set of initial building configurations to bias each initial building configuration toward the initial budget and number of household members. Then, the computer system can derive a future configuration using the prefabricated building elements from the initial building configuration based on the future budget and projected number of household members.

Therefore, the computer system can: generate initial and future configurations for a user based on user preferences; and derive a remodel plan to transform the initial build configuration into the future configuration.

### 5. Panelized Structural Building System

Generally, a panelized structural building system can include a set of prefabricated structural floor, wall, and roof panels that are constructed offsite (e.g., for the first time) onsite to form a complete, habitable building (e.g., a house, a pool house, a cabin, a multi-family residential apartment, a carriage house) with little or no onsite (structural) customization (e.g., or on-site trimming or modification) of these panels themselves. In particular, wall panels in this system include: hardpoints that define vertical and horizontal datums for accurate, repeatable connection to corresponding datums defined by hardpoints in floor and roof panels; and structural, load-carrying elements that connect these hardpoints both vertically and laterally but do not extend beyond datums (e.g., planar surfaces) defined by these hardpoints (or otherwise remain clear of features on adjacent panels), thereby preventing interference between these structural elements in the wall panel and adjacent floor and roof panels when these components are assembled, ensuring accurate location of the wall panel on a floor panel, and similarly ensuring accurate location of a roof panel on the wall panel.

Therefore, the panelized structural building system can include a set of floor, wall, and roof panels, each of which includes a set of features (e.g., hardpoints) that define datums for accurate, repeatable location on adjacent structural panels in the panelized structural building system such that a large (e.g., a 20′-wide by 40′ long) structure assembled from these structural panels exhibits high dimensional and geometric accuracy. Such high dimensional and geometric accuracy of the structure may then enable prefabricated interior and exterior façade panels to be assembled onto this structure to complete the building with little or no customization (e.g., or on-site trimming or modification) of these façade elements without sacrificing final fit and finish of the building as a whole.

For example, the panelized structural building system can be as described in U.S. Pat. No. 11,236,505, filed on 15 May 2020, which is incorporated in its entirety by this reference.

### 6. Initial Building Configuration

Generally, the computer system can generate a building plan corresponding to a building configuration of the panelized structural building system. More specifically, the computer system can generate the building plan specifying: an arrangement of a set of prefabricated building elements (e.g., wall panels, floor panels, roof panels, exterior façade panels, interior finishing panels) for assembly of a structure according to the building configuration; and a sequence for arranging each prefabricated building element in the set of prefabricated building elements according to the arrangement.

In one implementation, the computer system can: access location information associated with a lot; access property information based on the location information; access a set of user preferences; select a subset of building configurations, in a set of building configurations, based on the property information and the first set of preferences; and serve the subset of building configurations to a user of the computer system. In response to receiving selection of a building configuration in the subset of building configurations, the computer system can generate a building plan for the selected building configuration.

### 6.1 Location Information

Generally, the computer system can access location information associated with a lot on which to assemble the panelized structural building system.

In one implementation, the computer system can receive, from a user device, location information (e.g., address, lot number, parcel number) associated with the lot. For example, the computer system can: prompt a user device for location information; and receive the location information from the user device such as by prompting the user to take photos, videos, a series of images for photogrammetry, or lidar scans (or a combination of them) using their device or a device provided to them for this purpose.

In another implementation, the computer system can access the location information associated with a lot based on a user profile. For example, the computer system can access a user profile of a user accessing the computer system, the user profile including the location information.

### 6.2 Property Information

Generally, the computer system can access property information based on the location information.

In one implementation, the computer system can access property information associated with the location information. For example, the computer system can access property information associated with an address of a lot. In this example, the computer system can access a database (or a set of databases) storing the property information.

In another implementation, the computer system can access the property information including lot characteristics. For example, the computer system can access lot characteristics including lot shape, lot size, slope, topography, positions of structures on the lot, characteristics of these structures (e.g., commercial building, residential building, garage, accessory dwelling unit), etc.

Additionally or alternatively, the computer system can access the property information including a set of governmental requirements (e.g., laws, regulations) associated with the lot. For example, the computer system can access the set of governmental requirements including zoning requirements, building code requirements (e.g., building codes), etc.

### 6.3 Initial User Preferences

Generally, the computer system can access a set of user preferences of a user.

In one implementation, the computer system can receive a set of user preferences from a user device. For example, the computer system can: prompt the user device for the set of user preferences; and receive the set of user preferences from the user device.

In another implementation, the computer system can access the set of user preferences based on a user profile associated with the user. For example, the computer system can access a user profile of a user accessing the computer system, the user profile including the set of user preferences.

In one implementation, the computer system can access the set of user preferences including a budget, size (e.g., square footage), a number of bedrooms, a number of bathrooms, a number of kitchens, a number of levels, etc.

Additionally or alternatively, the computer system can access the set of user preferences including a ranking of a set of search optimizations. In one example, the computer system can access the set of user preferences including a ranking of a set of search optimizations in order of 1) a first search optimization for reducing cost, 2) a second search optimization for maximizing space, and 3) a third search optimization for matching according to the set of user preferences. In another example, the computer system can access the set of user preferences including a ranking of the set of search optimizations in order of 1) the third search optimization for matching according to the set of user preferences, 2) a fourth search optimization for future reconfiguration, and 3) the first search optimization for reducing cost.

### 6.3.1 Building Configuration Visualization

In one implementation, the computer system can access the set of user preferences by: generating a set of visual representations of building configurations; displaying the set of virtual representations to the user; and receiving user feedback (e.g., selection of a virtual representation of a preferred building configuration).

For example, the computer system can: generate and transmit a prompt to a computing device of a user, the prompt indicating a set of initial parameters such as a number of bedrooms and bathrooms for the initial building configuration; filter a set of possible building configurations based on the initial parameters; and identify a set of initial building configurations fulfilling the initial parameters. In one implementation, the computer system can prompt a user for user preferences via a large language model (LLM) or chatbot.

The computer system can then: generate a virtual representation for each building configuration of the set of initial building configurations; display each virtual representation on the computing device of the user; and transmit a prompt to the user to select a preferred building configuration.

In response to the user specifying initial parameters indicating a user preference for a one bedroom and one bathroom house, the computer system can identify a set of initial building configurations exhibiting one bedroom and one bathroom from the set of all possible building configurations (e.g., all possible combinations of arrangements of prefabricated building elements). The computer system can identify: a first building configuration exhibiting a large living space and kitchen with a small bedroom and small bathroom; and a second building configuration exhibiting a small living space and kitchen with a large bedroom and large bathroom. The computer system: generates a first virtual representation of the first building configuration; generates a second virtual representation of the second building configuration; and prompts the user to select a building configuration. In response to the user selecting the first virtual representation corresponding to the first building configuration, the computer system: identifies an initial user preference for living space and kitchen area over bedroom and bathroom area; identifies other building configurations fulfilling this user presence; and presents virtual representations of each building configuration fulfilling the user preference to the user. Therefore, the computer system can iteratively refine a set of user preferences and building configurations fulfilling those user preferences by generating virtual representations of a set of building configurations and prompting the user for feedback.

In one implementation, the computer system can: generate a set of build modules, each module defining a complete room (e.g., a bedroom, kitchen, or bathroom) of the building configuration; generate a virtual representation for each build module; display the virtual representations on the user device; and prompt the user to arrange each virtual representation corresponding to a build module. In response to user submission of a preferred floorplan (e.g., a set of arranged build modules), the computer system can: store the preferred floorplan as the initial building configuration; and generate a set of prefabricated building elements for construction of the initial building configuration. However, in response to user submission of a preferred floorplan violating a building code or zoning requirement (e.g., a floorplan that spans past property lines of the lot), the computer system can: annotate the virtual representation of the floorplan with an indication of a violation of the building code or zoning requirement; and render a revised floorplan biased toward the preferred floorplan fulfilling the building code and zoning requirements.

### 6.4 Building Code and Zoning Requirements

In one implementation, the computer system accesses a set of building code and zoning requirements associated with the location of the lot.

For example, the set of building code and zoning requirements can include: geometry parameters such as a maximum width and height of a structure on the lot; homeowner's association (“HOA”) parameters such as a minimum distance between a structure on the lot and a curb; egress requirements; energy performance requirements such as those required by building code or those required to achieve optional energy standards such as LEED, Energy Star, Net Zero, or Passive Haus; and seismic parameters such as a seismic profile of the location indicating structural requirements for the structure based on the seismic profile.

In one implementation, the computer system can access the set of building code and zoning requirements by: accessing a location of the lot; searching a database (e.g., a government database or database of information from previous builds or a pre-computed proprietary database) of building code and zoning requirements; and identifying a set of building code and zoning requirements within the database associated with the location of the lot.

### 6.5 Building Plan

Generally, in response to receiving selection (and/or confirmation) of a building configuration (e.g., a building configuration), the computer system can generate a building plan for the building configuration.

In one implementation, in Block S140, the computer system can generate a first building plan specifying a first arrangement of a first set of prefabricated building elements for assembly of a first structure according to the building configuration. For example, the computer system can generate the first arrangement of the first set of prefabricated building elements, the first set of prefabricated building elements including a first set of wall panels of a common geometry, a first set of floor panels of a common geometry, a first set of roof panels of a common geometry, a first set of exterior façade panels of a common geometry, a first set of interior finishing panels of a common geometry, and/or other prefabricated building elements (e.g., foundation elements, fixtures) assemblable into the first structure according to the building configuration. Additionally, the computer system can generate the first arrangement defining respective positions of each prefabricated building element—in the first set of prefabricated building elements—relative to the lot.

In another implementation, the computer system can generate the first building plan further specifying a sequence (e.g., an ordered set of steps) for arranging (e.g., installing) each prefabricated building element in the first set of prefabricated building elements according to the first arrangement. More specifically, the computer system can generate the sequence based on a load path analysis. For example, the computer system can generate the sequence including a step (or set of steps) of bracing a prefabricated building element (or subset of prefabricated building elements) in the first set of prefabricated building elements during installation based on the load path analysis.

Accordingly, the computer system can generate the sequence for arranging each prefabricated building element in the first set of prefabricated building elements according to the first arrangement based on the load path analysis to minimize an amount of material and a number of steps to support the first structure during installation, thus reducing total cost and build time of the first structure.

Additionally, the computer system can generate the building plan identifying the first set of prefabricated building elements and a cost estimate for the selected building configuration. More specifically, the computer system can generate the cost estimate based on the first set of prefabricated building elements, installation fees, permits, taxes, and/or any other fee.

In one implementation, the computer system can serve the building plan to a user device (e.g., a device associated with a customer, a device associated with a foreperson, a device associated with an administrator).

Additionally, the computer system can associate (or store) the building plan (and/or the first structure) with a user profile of a user.

### 7. Future Configuration

Generally, a panelized structural building system can initially be assembled into a first structure according to a first building configuration (e.g., an initial building configuration). More specifically, the panelized structural building system can include a first set of prefabricated building elements that are arranged according to a first arrangement-corresponding to the first building configuration—to assemble the first structure.

At a later time, the panelized structural building system (assembled as the first structure) can be disassembled (at least in part), and the panelized structural building system can be reassembled into a second structure-according to a second building configuration-utilizing at least a subset of the first set of prefabricated building elements. For example, the panelized structural building system can be reassembled into the second structure such that a first subset of the first set of prefabricated building elements is rearranged according to a second arrangement-corresponding to the second building configuration—to assemble the second structure.

Accordingly, the panelized structural building system can reutilize prefabricated building elements to assemble various structures over time, thereby reducing overall cost, environmental impact, and installation time of these structures.

Generally, the computer system can execute Blocks of the method S100 to reconfigure a first structure, according to a first building configuration (e.g., an initial building configuration), into a second structure according to a second building configuration (e.g., a future configuration). More specifically, the computer system can execute Blocks of the method S100 to generate a second building plan specifying: a second arrangement of a second set of prefabricated building elements for assembly into a second structure according to the second building configuration, the second set of prefabricated building elements including at least a subset of the first set of prefabricated building elements; and a sequence for arranging each prefabricated building element in the second set of prefabricated building elements according to the second arrangement based on the first arrangement.

In one implementation, the method S100 includes: accessing a set of future preferences of the user for the residential structure in Block S152; accessing a set of building code and zoning requirements for a build location of the residential structure in Block S154; and selecting a set of future configurations from a set of possible building configurations, the subset of future configurations fulfilling the set of building code and zoning requirements and approximating the set of future preferences of the user in Block S160.

### 7.1 Future Preferences of the User

The computer system can access a set of future preferences of the user for the residential structure in Block S152 of the method S100. In one implementation, the set of future preferences can include: a future budget (e.g., based on an income and a predicted income growth of the user); a duration until completion of the future configuration (e.g., five to twenty years); a projected number of future household members; and a preferred number of bedrooms and bathrooms. The computer system therefore prompts the user to provide a set of future preferences representing the user's current perception of their future residential needs and desires.

In one implementation, the computer system can define the set of future preferences to additionally include lifestyle preferences such as prioritizing entertaining over personal space. In this implementation, the computer system can filter the set of building configurations in response to this lifestyle preference by selecting building configurations including a majority of square footage of the building configuration for common spaces (e.g., kitchen and living rooms).

In one implementation, the computer system can access the set of future preferences of the user by: presenting a set of virtual representations of a subset of the set of possible building configurations; prompting the user to select a set of preferred characteristics from the set of virtual representations; generating a revised virtual representation of a possible building configuration exhibiting the preferred characteristics; and, in response to receiving user approval of the revised virtual representation, confirming the set of preferred characteristics as the set of future preferences.

The computer system can access the set of future preferences of the user via visualization of future configuration options by: prompting for user feedback; and refining the future configuration options. However, the computer system can access initial and future user preferences via any other process.

### 7.2 Future Configuration Selection

Generally, the computer system can: select a subset of building configurations, in a set of building configurations of a structure assembled from prefabricated building elements, based on the property information and the set of user preferences; and serve the subset of building configurations to a user device.

In one implementation, in Block S120, the computer system can select the subset of building configurations (e.g., three building configurations)—in the set of building configurations—that meet constraints defined by the property information (e.g., physical constraints defined by the lot characteristics, legal constraints defined by law and/or regulation) and that best match the set of user preferences.

For example, the computer system can select a first subset of building configurations—in the set of building configurations—that meet physical constraints defined by the lot characteristics and legal constraints defined by law and/or regulation. More specifically, the computer system can select the first subset of building configurations to include only building configurations that fall below 400 square feet based on an amount of available space on a lot, including an extant structure, on which to assemble the prefabricated building elements. The computer system can then select a second subset of building configurations—in the first subset of building configurations—that best match the set of user preferences, such as budget, size, and a ranking of a set of search optimizations. In this example, the computer system can select the second subset of building configurations based on a predefined mapping of combinations of user preferences to building configurations (e.g., building configurations that best match combinations of user preferences).

Additionally or alternatively, the computer system can calculate a respective set of scores, for each building configuration in the first subset of building configurations, based on the set of user preferences. For example, for a first building configuration in the first subset of building configurations, the computer system can: extract a first value in a first domain (e.g., cost) for the first building configuration; calculate a first score—in a first set of scores associated with the first building configuration—based on a similarity between the first value and a first user preference associated with the first domain (e.g., budget). Additionally, the computer system can: extract a second value in a second domain (e.g., square footage) for the first building configuration; and calculate a second score—in the first set of scores-based on a similarity between the second value and a second user preference associated with the second domain (e.g., size). The computer system can repeat these extraction and calculation operations for each user preference in the set of user preferences.

Additionally, the computer system can apply a respective weight to each score in the set of scores based on the ranking of search optimizations (e.g., weight of 1.2 for a score in a domain corresponding to a highest ranking search optimization, weight of 1.0 for a score in a domain corresponding to a second highest ranking search optimization, weight of 0.8 for score in a domain corresponding to a third highest ranking search optimization).

The computer system can then aggregate a composite score for the first building configuration based on the set of scores (e.g., a sum of the set of scores, a weighted sum of the set of scores).

The computer system can then select the second subset of building configurations—in the first subset of building configurations—based on highest composite score among a set of composite scores associated with the first subset of building configurations. In this example, the computer system can then select the second subset of building configurations characterized by highest composite scores among a set of composite scores associated with the first subset of building configurations (e.g., the second subset of building configurations including three building configurations exhibiting three highest composite scores among the set of composite scores associated with the first subset of building configurations).

Accordingly, the computer system can select building configurations that best match the set of user preferences and that meet the physical and/or legal constraints. Therefore, the computer system can streamline a user experience to arrive at a building configuration that can be assembled on a specified lot.

### 8. Selecting a Building Configuration from a Building Configuration Space

In one implementation, the computer system selects initial and/or future configurations from a multi-dimensional building configuration space including all possible combinations of the prefabricated building elements arranged in a building configuration.

For example, the computer system can isolate the subset of initial building configurations by: generating a multi-dimensional building configuration space defining the set of possible building configurations; defining a boundary within the multi-dimensional building configuration space based on the set of initial preferences and the set of building code and zoning requirements, the boundary surrounding a volume; and identifying the set of initial building configurations within the volume.

In one implementation, the multi-dimensional building configuration space defines a graphical space (e.g., a vector space) including a set of dimensions each defining a characteristic of a building configuration. For example, the multi-dimensional building configuration space can include a first dimension (e.g., a first axis) representing a number of stories of the building configuration wherein a first position within the first dimension represents a single-story building configuration and a second position within the first dimension represents a two-story building configuration. The multi-dimensional building configuration space can include a second dimension representing a number of bedrooms within a building configuration wherein a first position within the second dimension represents a one-bedroom building configuration and a second position within the second dimension represents a two-bedroom building configuration. In this example, a single-story, two-bedroom building configuration occupies a position within the multi-dimensional building configuration space represented by the vector [1,2]. The multi-dimensional building configuration space can additionally or alternatively include dimensions for any other characteristics of a building configuration.

### 8.1 Populating the Building Configuration Space

In one implementation, the computer system populates point representations of building configurations (e.g., a point occupying a location within the building configuration space according to characteristics of the building configuration) based on possible combinations of prefabricated building elements.

In one implementation, the computer system populates the building configuration space with all possible closed building configurations of the set of prefabricated building elements. For example, the computer system can populate the building configuration space with a building configuration including six prefabricated, 4×4 foot, square panels arranged in a cubic formation. The computer system can locate this building configuration at point [1,0] according to the dimensions described above due to the cubic building configuration not including a bedroom. The computer system additionally populates the building configuration space with building configurations (e.g., floorplans of residential structures) including any other combination of bedrooms and bathrooms. In one implementation, the computer system can populate a limited building configuration space (e.g., including building configurations with 0-10 stories and 0-10 bedrooms) to reduce a storage footprint of the multi-dimensional building configuration space within a remote computer system and thereby decrease a latency of populating the building configuration space.

Therefore the computer system populates the multi-dimensional building configuration space with a population of possible building configurations based on the available prefabricated building elements.

### 8.2 Bounding the Building Configuration Space

In one implementation, the computer system bounds the building configuration space to isolate a set of building configurations. The computer system can project boundaries into the building configuration space based on user preferences (e.g., budget, desired square footage), building code and zoning requirements, location-related requirements (e.g., seismic or HOA requirements) and other limiting factors.

For example, the computer system can project a set of boundaries into the multi-dimensional space, the set of boundaries including: a first boundary defining a first volume of the multi-dimensional space including a set of building configurations fulfilling the building code and zoning requirements of the build location; and a second boundary defining a second volume including a set of building configurations fulfilling the initial preferences of the user. The computer system can then: derive a first intersection of the first volume and the second volume, the first intersection including a set of initial building configurations fulfilling the building code and zoning requirements of the build location and fulfilling the initial preferences of the user; project a third boundary into the multi-dimensional space, the third boundary defining a third volume including a set of building configurations fulfilling the future preferences of the user; and derive a second intersection of the first volume and the third volume, the second intersection including the set of future configurations fulfilling the building code and zoning requirements of the build location and fulfilling the future preferences of the user.

The computer system can therefore: identify a set of building configurations within the multi-dimensional building configuration space fulfilling a set of requirements; and serve visual representations of the set of building configurations to the user for the user to select a preferred building configuration for an initial or future build.

### 9. Building Configuration Visualization

In one implementation, in Block S130, the computer system can serve the subset of building configurations (e.g., the second subset of building configurations described above) to the user device.

For example, the computer system can generate an interface including a visualization of the second subset of building configurations (e.g., a first visualization of a floorplan layout corresponding to a first building configuration in the second subset of building configurations, a second visualization of a floorplan layout corresponding to a second building configuration in the second subset of building configurations). In this example, the computer can serve the prompt to a user device.

Additionally, the computer system can generate the interface specifying a respective set of characteristics (e.g., cost, size, number of bedrooms, number of bathrooms) for each building configuration in the second subset of building configurations.

Additionally, the computer system can generate the interface further including, for each building configuration in the second subset of building configurations, a visualization of a candidate building configuration (e.g., a future configuration) based on a set of modifications to the respective building configuration. For example, the computer system can generate an interface including a first visualization of a first building configuration (e.g., 400 sq ft studio floorplan) and a second visualization of a candidate building configuration (e.g., 800 sq ft one-bedroom floorplan) based on a set of modifications to the first building configuration (i.e., the first building configuration can be expanded and/or modified at a later time into the candidate building configuration based on application of the set of modifications to the first building configuration). The computer system can generate the interface further specifying a respective set of characteristics for each candidate building configuration.

Accordingly, the computer system can present to a user device: a building configuration that can initially be assembled into a first structure on the specified lot; and a candidate building configuration that can, at a later time, be assembled and/or modified from the first structure into a second structure. Therefore, the computer system can present—to a user—a set of options that best match the user's needs and/or preferences over time.

In one variation, the computer system can generate the interface including: the first visualization of the first building configuration (e.g., 400 sq ft studio floorplan)—in the second subset of building configurations—as a future configuration; and a third visualization of a candidate building configuration (e.g., 200 sq ft studio floorplan) as an initial building configuration (i.e., the candidate building configuration can be expanded and/or modified at a later time into the first building configuration based on application of a set of modifications to the candidate building configuration). For example, the computer system can generate the interface including the first visualization of the first building configuration and the second visualization of the candidate building configuration in response to detecting a cost associated with the first building configuration exceeding a budget in the set of user preferences.

Accordingly, the computer system can present to a user device: a candidate building configuration that can initially be assembled into a first structure on the specified lot (e.g., based on a cost associated with the candidate building configuration falling below an initial budget); and a building configuration that can, at a later time (e.g., when a cost associated with the building configuration falls below a later budget), be assembled and/or modified from the first structure into a second structure. Therefore, the computer system can present—to a user—a set of options that best match the user's needs and/or preferences over time.

### 10. Iterative Search

Generally, the computer system can iteratively present new subsets of building configurations based on user feedback.

In one implementation, the computer system can iteratively: serve a second subset of building configurations in the set of building configurations; receive selection of a first building configuration in the second subset of building configurations from a user device; select a third subset of building configurations, in the set of building configurations, based on the selection of the first building configuration; and serve the third subset of building configurations.

In one example, the computer system can serve a second subset of building configurations in the set of building configurations, the second subset of building configurations including a first building configuration (e.g., one-bedroom unit style A), a second building configuration (e.g., one-bedroom unit style B), and a third building configuration (e.g., one-bedroom unit style C). In this example, the computer system can receive selection of the first building configuration from the user device. Additionally, the computer system can associate (or store) the selection of the first building configuration in a user profile and/or in the set of user preferences.

The computer system can then select a third subset of building configurations—in the set of building configurations—based on the selection of the first building configuration, such as in an analogous (e.g., similar, identical) manner as described above. In this example, the computer system can select the third subset of building configurations including a third building configuration (e.g., one-bedroom unit style A with kitchen style C), a fourth building configuration (e.g., one-bedroom unit style A with kitchen style D), and a fifth building configuration (e.g., one-bedroom unit style with an absence of a kitchen). Additionally or alternatively, the computer system can select the third subset of building configurations based on the selection of the first building configuration, the property information, and/or the set of user preferences. Additionally or alternatively, the computer system can select the third subset of building configurations based on a tree (e.g., decision tree) including a parent node corresponding to the first building configuration and a set of child nodes extending from the parent node, the third subset of building configurations corresponding to the set of child nodes. The computer system can serve the third subset of building configurations as described above.

Continuing this example, the computer system can: receive selection of the third building configuration from the user device; and store the selection of the third building configuration in the user profile and/or in the set of user preferences. The computer system can select a fourth subset of building configurations—in the set of building configurations—based on the selection of the third building configuration, the third subset of building configurations including a sixth building configuration (e.g., one-bedroom unit style A with kitchen style C and bathroom style E), a seventh building configuration (e.g., one-bedroom unit style A with kitchen style C and bathroom style F), and an eighth building configuration (e.g., one-bedroom unit style A with kitchen style C and an absence of a bathroom). The computer system can then serve the fourth subset of building configurations to the user device.

In one variation, the computer system can receive selection of an area (e.g., kitchen, bathroom) of a building configuration that a user wants to modify. In response to receiving selection of the area, the computer system can: select a subset of building configurations corresponding to the selected area; and serve the subset of building configurations to the user device.

For example, in response to receiving selection of a kitchen area in a first building configuration (e.g., one-bedroom unit style A), the computer system can select the third subset of building configurations including the third building configuration (e.g., one-bedroom unit style A with kitchen style C), the fourth building configuration (e.g., one-bedroom unit style A with kitchen style D), and the fifth building configuration (e.g., one-bedroom unit style with an absence of a kitchen). The computer system can then serve the third subset of building configurations to the user device.

In one implementation, the computer system can present a set of building configurations to a user for feedback and iteratively refine the set of building configurations based on the user feedback. For example, the computer system can: generate a set of virtual representations including a virtual representation of each initial building configuration; present the set of virtual representations to a computing device of the user; in response to absence of a user selection of the virtual representation of the set of set of virtual representations, prompt the user to select a set of preferred characteristics from the set of virtual representations; generate a revised initial building configuration according to the set of preferred characteristics; generate a revised virtual representation of the revised initial building configuration; and, in response to receiving user approval of the revised virtual representation, generating a schedule to augment the revised initial building configuration to yield the future configuration.

Accordingly, the computer system can iteratively narrow a search of the set of building configurations to a building configuration based on specific user feedback. Therefore, the computer system can streamline a user experience to arrive at a building configuration through a guided (or freeform) series of prompts.

### 11. Remodel Schedule

The method S100 includes generating a schedule to augment the initial building configuration with additional prefabricated building elements to transform the initial build configuration into the future configuration in Block 168. The computer system defines the schedule (e.g., a remodel schedule) indicating a timeline of augmentations to a first building configuration to transform the first building configuration into a second building configuration, such as via additions of prefabricated building elements or rearrangements of prefabricated building elements. The computer system can define the schedule to include a set of intermediate building configurations (e.g., between the initial building configuration and future configuration), each building configuration annotated with: an approximate timing of installation of additional prefabricated building elements; and a cost estimate of materials and installation.

For example, the computer system can generate the remodel schedule by: defining a set of intermediate building configurations between the initial building configuration and the future configuration, each intermediate building configuration of the set of intermediate building configurations fulfilling a livable residence requirement; and, for each intermediate phase of the set of intermediate phases, displaying a virtual representation of the intermediate building configuration.

The computer system can further define a first intermediate building configuration by: identifying an intermediate set of prefabricated building elements to add to the initial building configuration to yield the intermediate building configuration; identifying a cost of the intermediate building configuration; calculating a proportion of reused prefabricated building elements from the initial building configuration in the intermediate building configuration; and serving the cost, the proportion, and a virtual representation of the intermediate set of prefabricated building elements to the user.

For example, the computer system can: define an initial building configuration including an initial set of prefabricated building elements defining a one bedroom and one bathroom residential structure; define a future configuration including a future set of prefabricated building elements defining a four bedroom and three bathroom residential structure (including the original one bedroom and one bathroom from the initial building configuration); and define an intermediate building configuration including two bedrooms and one bathroom. The computer system can further: identify a set of intermediate prefabricated building elements including a set of intermediate panels to define a set of walls of the new bedroom of the intermediate building configuration; and identify a selection of initial panels of the initial building configuration for removal from the initial building configuration.

In one implementation, the computer system can define the remodel schedule by: accessing a yearly income of the user or the household the user; accessing a target duration between implementation of the initial building configuration and implementation of the future configuration (e.g., five years, 10 years, 15 years); accessing a predicted income growth within the duration (e.g., 10% income growth per year); calculating a periodic (e.g., every one, three, or five years) user budget for upgrading the building configuration based on the predicted; and identifies a set of intermediate building configurations at an intermediate build frequency (e.g., a time between each remodel) according to the periodic user budget. Therefore, the computer system can: define the remodel schedule based on an income and income growth of the user; and define the intermediate building configurations according to a budget of a user over the duration of the remodel schedule.

### 11.1 Modular Add-Ons

In one implementation, the computer system defines the remodel schedule including a set of modular add-ons to the initial building configuration to yield the future configuration. The computer system can define each modular add-on defining a complete room (e.g., a kitchen, bathroom, bedroom, living room etc.) that can be added to the initial building configuration without significant disassembly of the initial building configuration. For example, the computer system can define a remodel schedule including a modular bedroom add-on to transform a one bedroom, one bathroom building configuration into a two bedroom two bathroom building configuration. The computer system can define the modular bedroom add-on such that a single panel (e.g., a prefabricated building element) of the initial building configuration is removed to connect the modular bedroom add-on to the initial building configuration to yield the two bedroom building configuration.

In one implementation, the computer system can define complete room groups to be added to a current building configuration in each intermediate building configuration. For example, the computer system can define a complete room group including a bedroom and a hallway connecting the bedroom to an extant portion of the build configuration. The computer system can also define a complete room group including a bedroom, a hallway, and a bathroom such that the addition of each bedroom to the building configuration includes addition of a bathroom proximal the bedroom. Therefore, the computer system can define a set of complete room groups to add to the initial building configuration to transform the initial building configuration into the future building configuration.

### 11.2 Remodel Schedule Via Building Configuration Space

In one implementation, the computer system defines the remodel schedule within the building configuration space. For example, the computer system can: present a set of initial building configurations (from an intersection of an initial user preference volume and a building code and zoning requirements volume); present a set of future configurations (from an intersection of a future user preference volume and a building code and zoning requirements volume); and, in response to selection of a first initial building configuration from the set of initial building configurations and selection of a second future configuration from the set of future configurations, define the remodel schedule based on a location of the first initial building configuration within the building configuration space relative to a location of the second future configuration within the building configuration space.

In one implementation, the computer system can: define a connection line between the location of the first initial building configuration and the location of the second future configuration within the building configuration space; and identify a set of intermediate building configurations along or proximal to the connection line fulfilling the building code and zoning requirements and within projected user budget based on the predicted income growth of the user. The computer system can then: generate a set of visualizations of the set of intermediate building configurations; display the set of visualizations of the set of intermediate building configurations of the user; and prompt the user to select a subset of the set of visualizations. In response to receiving user selection of the subset, the computer system can define the building configurations corresponding to the selected subset of visualizations as the set of intermediate building configurations.

Therefore, the computer system can: identify possible intermediate building configurations within the building configuration space; and derive the remodel schedule based on selected intermediate building configurations fulfilling user preferences and budgets.

### 11.3 Multiple Future Configurations

In one implementation, the computer system can define the remodel schedule including multiple options for future configurations. The computer system: defines an exact initial building configuration based on the user's current needs and preferences; and defines an approximate future building configuration based on the user's current perception of her future preferences.

For example, the system can: filter a set of possible future building configurations to generate set of additional alternative future building configurations that specify a minimum quantity of structural, exterior façade, and interior façade components not enumerated in the initial building configuration and specify a minimum quantity of positional changes of structural components from the initial building configuration to the alternative future building configuration; present the set of alternative future configurations to the user for user confirmation and/or ranking by preference; and generate a set of remodel pathways between the initial building configuration and the set of alternative future building configurations.

### 12 Time-Based Reconfiguration

In one implementation, the computer system can detect a reconfiguration event based on an expiration of a threshold amount of time. For example, the computer system can detect a reconfiguration event based on an expiration of a threshold amount of time (e.g., three years, five years, ten years) succeeding completion of a first structure according to a first building configuration.

In one implementation, in response to detecting a reconfiguration event, the computer system can access a user profile associated with a user in Block S116. More specifically, the computer system can access the user profile (e.g., user profile associated with the first structure), the user profile including location information associated with a lot, property information, a set of user preferences, and the first building plan for the first structure.

Additionally, the computer system can receive an updated set of user preferences from a user device, such as an update budget, an updated size, an updated number of bedrooms, an updated number of bathrooms, an updated number of kitchens, an updated number of levels, etc. Additionally or alternatively, the computer system can receive an updated ranking of a set of search optimizations.

In one implementation, the computer system can select the candidate building configuration (e.g., future configuration) corresponding to the first building configuration. For example, the computer system can: select the candidate building configuration (e.g., 800 sq ft one-bedroom floor plan) previously presented and corresponding to the first building configuration (e.g., 400 sq ft studio floorplan); and serve a visualization of the candidate building configuration.

In one variation, in Block S120, the computer system can select a subset of building configurations, in the set of building configurations, based on the property information, the set of user preferences, the first building plan, and/or the reconfiguration event, such as described above. For example, the computer system can select a subset of building configurations that best match the set of user preferences (e.g., budget, size, and a ranking of a set of search optimizations) based on the first building plan (e.g., highest reutilization of the first set of prefabricated building elements, minimal rearrangement of the first set of prefabricated building elements in the first arrangement). In this example, the computer system can select the subset of building configurations that best match the set of user preferences and that are also characterized by highest proportion of the first set of prefabricated building elements reutilized in a second set of prefabricated building elements corresponding to the building configuration. Additionally or alternatively, the computer system can select the subset of building configurations that best match the set of user preferences and that are also characterized by fewest prefabricated building elements—in the first set of prefabricated building elements in the first arrangement—rearranged into the second arrangement corresponding to the building configuration.

Additionally, the computer system can select the subset of building configurations further based on a load path analysis of a particular building configuration (e.g., requiring minimal bracing when rearranging prefabricated building elements in the first arrangement corresponding to the first building configuration into an arrangement corresponding to the particular building configuration).

Accordingly, the computer system can select building configurations that maximize reutilization of prefabricated building elements already installed on the lot, thereby reducing overall cost and installation time of the second structure.

In one implementation, the computer system can for each initial building configuration in the set of initial building configurations: identify a set of building elements specified in the initial building configuration; generate a future configuration based on the set of building elements, the future configuration fulfilling the set of future user parameters and specifying more than a minimum threshold proportion of building elements in the set of building elements. For each initial building configuration, the computer system: calculates a proportion of building elements within the initial building configuration present in the future building configuration. For example, the threshold proportion of building elements in the set of building elements can be equal to 90% meaning that 90% of the building elements from the initial building configuration are present in the future building configuration. Each of the initial building configurations and/or the future configurations can be manually generated (e.g., by an architect or designer) or automatically generated by the computer system.

Further, the computer system can: generate a future configuration based on the set of building elements present in the initial building configuration, the future configuration fulfilling the set of future user parameters; calculate a proportion of building elements, in the set of building elements, specified in the second future configuration that are present in the initial building configuration; and in response to the second proportion of building elements falling below the minimum threshold proportion, discard the second future configuration.

In one implementation, in Block S130, the computer system can serve the subset of building configurations to a user device. Additionally, the computer system can iteratively present new subsets of building configurations based on user feedback, as described above.

In another implementation, in Block S140, in response to receiving selection (and/or confirmation) of a building configuration (e.g., a second building configuration) the computer system can generate a second building plan specifying a second arrangement of a second set of prefabricated building elements for assembly of a second structure according to the building configuration, such as described above. More specifically, the computer system can generate the second building plan specifying the second arrangement of the second set of prefabricated building elements, the second set of prefabricated building elements including a second set of wall panels, a second set of floor panels, a second set of roof panels, a second set of exterior façade panels, a second set of interior finishing panels, and/or other prefabricated building elements assemblable into the second structure according to the second building configuration. For example, the computer system can generate the second building plan specifying the second arrangement of the second set of prefabricated building elements, the second set of prefabricated building elements including at least a subset of the first set of prefabricated building elements (e.g., the second set of wall panels including at least a subset of the first set of wall panels, the second set of floor panels including at least a subset of the first set of floor panels, the second set of roof panels including at least a subset of the first set of roof panels, the second set of exterior façade panels including at least a subset of the first set of exterior façade panels, the second set of interior finishing panels including at least a subset of the first set of interior finishing panels). Additionally, the computer system can generate the second building plan specifying the second arrangement defining respective positions of each prefabricated building element—in the second set of prefabricated building elements—relative to the lot.

Additionally, the computer system can generate the second building plan further specifying a sequence for arranging each prefabricated building element in the second set of prefabricated building elements according to the second arrangement (e.g., from the first arrangement to the second arrangement). For example, the computer system can generate the sequence including a step of rearranging a first wall panel (e.g., a first wall panel included the first set of prefabricated building elements and reutilized in the second set of prefabricated building elements) from a first position—according to the first arrangement—to a second position according to the second arrangement.

In one implementation, the computer system can generate the sequence based on a load path analysis. More specifically, the computer system can generate the sequence including a step (or set of steps) of bracing a prefabricated building element (or subset of prefabricated building elements) in the second set of prefabricated building elements during installation based on the load path analysis. For example, the computer system can detect that a load on a second wall panel—connected to the first wall panel—will exceed a threshold load-carrying capacity if the first wall panel is removed (e.g., based on the load path analysis). The computer system can then generate the sequence including: a first step of bracing a second wall panel connected to the first wall; a second step of disconnecting the first wall panel from the second wall panel; a third step of removing the first wall panel from the first position; and a fourth step of arranging the first wall panel at the second position according to the second arrangement.

Accordingly, the computer system can generate the sequence for arranging each prefabricated building element in the second set of prefabricated building elements according to the second arrangement based on the load path analysis, thereby ensuring the structure is adequately supported as prefabricated building elements are rearranged and installed.

In another implementation, the computer system can serve the second building plan to a user device as described above.

Additionally, the computer system can associate (or store) the second building plan with a user profile.

In one implementation, the computer system can queue delivery of additional prefabricated building elements (e.g., a difference between the second set of prefabricated building elements and the first set of prefabricated building elements) to the lot.

### 12.1 Instrumented Reconfiguration

Generally, a panelized structural building system can include a set of instruments (e.g., sensors) to measure utilization of the computer system according to a particular building configuration.

In one example, the computer system can include a set of traffic sensors (e.g., installed in the set of floor panels) configured to detect traffic in different areas within a building configuration. In another example, the computer system can include a set of motion sensors (e.g., installed in the set of wall panels, installed in a set of ceiling panels) configured to detect motion in different areas within the building configuration. In yet another example, the computer system can include a set of weight sensors (e.g., installed in foundation elements) configured to detect weight distribution in different areas within the building configuration. In yet another example, the computer system can include a set of sensors (e.g., installed in toilets, installed in sinks, installed in showers, installed in baths, installed in plumbing) configured to detect water usage in various fixtures in the building configuration. The computer system can collect data corresponding to these sensors and associate the collected data with a user profile.

In one implementation, the computer system can access the collected data corresponding to the set of instruments. In one example, the computer system can access a user profile including the collected data. In another example, the computer system can access the collected data from the set of instruments.

In one implementation, the computer system can: analyze the collected data; and generate utilization metrics for the building configuration and/or for different areas within the building configuration based on the collected data. More specifically, the computer system can detect overutilization (or underutilization) of different areas within the building configuration based on the collected data and/or utilization metrics.

In one example, the computer system can detect overutilization of a bathroom based on a set of utilization metrics (e.g., average daily utilization over a year) representing high average daily water utilization (e.g., throughout a day) in the bathroom and high density traffic around a sink in the bathroom. In this example, the computer system can detect overutilization of the bathroom based on the set of utilization metrics (or a subset of utilization metrics (e.g., a daily average of 1.2 people positioned by the sink between 7 AM and 8 AM)) exceeding a threshold (e.g., a daily average of 0.8 people positioned by the sink between 7 AM and 8 AM).

In another example, the computer system can detect underutilization of a room based on the set of utilization metrics representing low average daily traffic into the room. In this example, the computer system can detect underutilization of the room based on the set of utilization metrics (or a subset of utilization metrics (e.g., a daily average of 0.1 people entering the room)) falling below a threshold (e.g., a daily average of 0.8 people entering the room)).

In one implementation, the computer system can detect a reconfiguration event in response to detecting overutilization and/or underutilization based on the utilization metrics. For example, the computer system can detect a reconfiguration event in response to detecting overutilization of a bathroom and/or in response to detecting underutilization of a room. Additionally or alternatively, the computer system can detect the reconfiguration event based on an expiration of a threshold amount of time succeeding completion of a first structure according to a first building configuration. Additionally or alternatively, the computer system can detect the reconfiguration event in response to receiving an input (or a set of inputs), from a user device, representing reconfiguration.

In one implementation, in response to detecting a reconfiguration event, the computer system can access a user profile in Block S116. More specifically, the computer system can access the user profile, the user profile including location information associated with a lot, property information, a set of user preferences, the first building plan corresponding to the first structure, and the utilization metrics.

Additionally, the computer system can receive a set of inputs corresponding to an updated set of user preferences as described above.

In one implementation, in Block S120, the computer system can select a subset of building configurations, in the set of building configurations, based on the property information, the set of user preferences, the first building plan, and the utilization metrics, such as described above. For example, the computer system can select a subset of building configurations that best match the set of user preferences (e.g., budget, size, and a ranking of a set of search optimizations) based on the first building plan (e.g., highest reutilization of the first set of prefabricated building elements, minimal rearrangement of the first set of prefabricated building elements in the first arrangement) and based on the utilization metrics (e.g., overutilization of a bathroom, underutilization of a room). In this example, the computer system can select the subset of building configurations that best match the set of user preferences and that are based on the utilization metrics, the subset of building configurations including: a second building configuration characterized by rearranging (e.g., removing, transforming) the underutilized room and expanding the overutilized bathroom (e.g., adding an additional sink); and a third building configuration characterized by rearranging (e.g., removing, transforming) the underutilized room and adding another bathroom.

Accordingly, the computer system can select building configurations that optimize utilization based on actual historical utilization data. Therefore, the computer system can narrow a search of the set of building configurations to a building configuration based on actual user need in an absence of direct user feedback.

Additionally, the computer system can select the subset of building configurations further based on a load path analysis of a particular building configuration (e.g., requiring minimal bracing when rearranging prefabricated building elements in the first arrangement corresponding to the first building configuration into an arrangement corresponding to the particular building configuration).

In one implementation, in Block S130, the computer system can serve the subset of building configurations to a user device. Additionally, the computer system can iteratively present new subsets of building configurations based on user feedback, as described above.

In another implementation, in Block S140, in response to receiving selection (and/or confirmation) of a building configuration (e.g., a second building configuration), the computer system can generate a second building plan specifying a second arrangement of a second set of prefabricated building elements for assembly of a second structure according to the building configuration, such as described above.

Furthermore, Blocks of the method S100 can also be executed by the computer system to: detect a reconfiguration event (e.g., changes or imbalances in building occupancy, building budget increases, future scheduled events); repeat the foregoing process to automatically generate a set of new possible arrangements of these prefabricated building elements initially assembled into the first structure (and additional prefabricated building elements) that form a different building configuration that may better meet a user's needs or interests based on the reconfiguration event; and present the new possible arrangements to a user for confirmation. Once a new arrangement is selected and confirmed by the user, Blocks of the method S100 can be executed by the computer system to: generate a second building plan specifying the new arrangement of prefabricated building elements for assembly into a new structure and a sequence for arranging these prefabricated building elements according to the new arrangement; and queue delivery of additional prefabricated building elements to the lot.

In one implementation, Blocks of the method S100 can be executed by the computer system to: collect utilization data in an existing panelized structural building system assembled into a first structure on a lot; present a subset of building configurations to reconfigure the existing panelized structural building system based on the utilization data (e.g., to mitigate overutilization and/or underutilization of various areas within a building configuration); and generate a second building plan associated with a new building configuration selected by the user. Accordingly, the computer system can select (and present) building configurations that optimize utilization based on actual historical utilization data. Therefore, the computer system can narrow a search of the set of building configurations to a building configuration based on actual user need in an absence of direct user feedback.

### 13. Conclusion

The method as described above can be used with prefabricated building elements such as a panelized building system including unitized panels assemblable into a structure. However, the method described herein also applies to customized panels and traditional building elements.

The computer systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor, but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A method comprising:
accessing a set of initial preferences of a user for a residential structure of the user;
accessing a set of future preferences of the user for the residential structure;
accessing a set of building code requirements for a build location of the residential structure;
defining a multi-dimensional space of possible building configurations, each building configuration representing a combination of building element arrangements;
selecting a set of initial building configurations from a set of possible building configurations by:
projecting a set of boundaries into the multi-dimensional space, the set of boundaries comprising:
a first boundary defining a first volume of the multi-dimensional space comprising a set of building configurations fulfilling the building code requirements of the build location; and
a second boundary defining a second volume comprising a set of building configurations fulfilling the initial preferences of the user;
deriving a first intersection of the first volume and the second volume, the first intersection comprising the set of initial building configurations:
fulfilling the building code requirements of the build location; and
fulfilling the initial preferences of the user;
selecting a set of future configurations from a set of possible building configurations by:
projecting a third boundary into the multi-dimensional space, the third boundary defining a third volume comprising a set of building configurations fulfilling the future preferences of the user; and
deriving a second intersection of the first volume and the third volume, the second intersection comprising the set of future configurations:
fulfilling the building code requirements of the build location; and
fulfilling the future preferences of the user; and
in response to user selection of a first initial building configuration in the set of initial building configurations and a first future configuration in the set of future configurations:
generating a schedule to augment the initial building configuration with additional building elements to transform the initial build configuration into the future configuration.

2. A method comprising:
accessing a set of future preferences of a user;
accessing a set of building code requirements for a build location of a residential structure of the user;
selecting a set of future configurations from a set of possible building configurations, the subset of future configurations:
fulfilling the set of building code requirements; and
approximating the set of future preferences of the user;
accessing a set of initial preferences of the user;
for each future configuration in the set of future configurations:
segmenting the future configuration into a set of prefabricated building elements; and
generating an initial building configuration based on the set of prefabricated building elements, the initial building configuration:
fulfilling the set of initial preferences of the user;
maximizing reuse of the set of prefabricated building elements; and
minimizing a number of new prefabricated building elements; and
in response to receiving user selection of the initial building configuration, generating a schedule to augment the initial building configuration with additional prefabricated building elements to transform the initial build configuration into the future configuration.

3. The method of claim 2:
wherein accessing the set of future living preferences of the user comprises accessing:
a future budget indicating a projected maximum cost executing the schedule to transform the initial building configuration into the future building configuration;
a timeline indicating a target completion date of the future building configuration; and
a projected number of household members predicted to live within the future building configuration;
wherein accessing the set of building code requirements for the build location comprises accessing:
a set of zoning requirements; and
a set of structural requirements;
wherein selecting the subset of future configurations comprises:
filtering the set of possible building configurations to a subset of building configurations fulfilling the zoning requirements and the structural requirement; and
filtering the subset of building configurations to the subset of future configurations fulfilling the future budget, the timeline, and the projected number of household members;
wherein accessing the set of initial user parameters comprises accessing:
an initial number of household members; and
an initial budget; and
wherein generating the initial building configuration comprises:
generating a combination of the set of prefabricated building elements to generate the initial building configuration fulfilling the initial budget and the initial number of household members.

4. The method of claim 2, wherein generating the schedule comprises:
identifying a set of prefabricated building elements to add to the initial building configuration to transform the initial build configuration into the future configuration;
defining a frequency to add a subset of the set of prefabricated building elements to the initial building configuration; and
generating the schedule based on the frequency to add the set of prefabricated building elements to the initial build.

5. The method of claim 2, wherein generating the schedule to augment the initial building configuration comprises:
defining a set of intermediate building configurations between the initial building configuration and the future configuration, each intermediate building configuration of the set of intermediate building configurations fulfilling a livable residence requirement; and
for each intermediate phase of the set of intermediate phases, displaying a virtual representation of the intermediate building configuration.

6. The method of claim 5, wherein defining the set of intermediate building configurations comprises, for a first intermediate building configuration:
identifying an intermediate set of prefabricated building elements to add to the initial building configuration to yield the intermediate building configuration;
identifying a cost of the intermediate building configuration;
calculating a proportion of reused prefabricated building elements from the initial building configuration in the intermediate building configuration; and
serving the cost, the proportion, and a virtual representation of the intermediate set of prefabricated building elements to the user.

7. The method of claim 2, wherein accessing the set of future preferences of the user comprises:
presenting a virtual representation of a subset of the set of possible building configurations;
prompting the user to select a set of preferred characteristics from the set of virtual representations;
generating a revised virtual representation of a possible building configuration exhibiting the preferred characteristics; and
in response to receiving user approval of the revised virtual representation, confirming the set of preferred characteristics as the set of future preferences.

8. The method of claim 2, further comprising:
generating a set of virtual representations comprising a virtual representation of each initial building configuration;
presenting the set of virtual representations to a computing device of the user; and
in response to absence of a user selection of the virtual representation of the set of virtual representations:
prompting the user to select a set of preferred characteristics from the set of virtual representations;
generating a revised initial building configuration according to the set of preferred characteristics;
generating a revised virtual representation of the revised initial building configuration; and
in response to receiving user approval of the revised virtual representation, generating a schedule to augment the revised initial building configuration to yield the future configuration.

9. The method of claim 2, wherein selecting the subset of future configurations comprises:
generating a multi-dimensional building configuration space defining the set of possible building configurations;
defining a boundary within the multi-dimensional building configuration space based on the set of future preferences and the set of building code requirements, the boundary surrounding a volume; and
identifying the set of future configurations within the volume.

10. The method of claim 2, wherein generating the initial building configuration comprises:
generating a set of modules comprising the initial building configuration;
rendering a virtual representation of the set of modules;
prompting the user to arrange the virtual representation of the set modules via a user interface; and
in response to user defining a module arrangement violating building code requirements:
annotating the virtual representation of the set of modules with an indication of a building code requirements violated; and
rendering a revised module arrangement biased toward the module arrangement defined by the user, the revised module arrangement fulfilling the building code requirements.

11. A method comprising:
accessing a set of initial preferences of a user;
accessing a set of building code requirements for a build location of a residential structure;
selecting set of initial building configurations from a set of possible building configurations:
approximating the set of initial preferences of the user; and
fulfilling the set of building code requirements;
accessing a set of future preferences of a user;
for each initial building configuration in the set of initial building configurations:
identifying a set of building elements specified in the initial building configuration;
generating a future configuration based on the set of building elements, the future configuration:
fulfilling the set of future user parameters; and
specifying more than a minimum threshold proportion of building elements in the set of building elements;
generating a first virtual representation of the initial building configuration;
generating a second virtual representation of the future configuration; and
displaying the first virtual representation and the second virtual representation; and
in response to selection of the first virtual representation:
generating a remodel schedule to convert the initial building configuration of the first virtual representation to the future build configuration of the first virtual representation.

12. The method of claim 11, wherein selecting the subset of initial building configurations comprises:
generating a multi-dimensional building configuration space defining the set of possible building configurations;
defining a boundary within the multi-dimensional building configuration space based on the set of initial preferences and the set of building code requirements, the boundary surrounding a volume; and
identifying the set of initial building configurations within the volume.

13. The method of claim 11, wherein the threshold proportion of building elements in the set of building elements is 90%.

14. The method of claim 11, wherein the set of initial building configurations are manually generated.

15. The method of claim 11, wherein the set of initial building configurations are automatically generated by a computer system.

16. The method of claim 11, further comprising:
generating a second future configuration based on the set of building elements, the future configuration fulfilling the set of future user parameters; and
calculating a second proportion of building elements, in the set of building elements, specified in the second future configuration; and
in response to the second proportion of building elements falling below the minimum threshold proportion:
discarding the second future configuration.
